(19) United States
(12) Patent Application Publication
(10) Pub. No.: US 2015/0041390 A1
(43) Pub. Date: Feb. 12, 2015

(54) CARBON BLOCK FILTER FOR REMOVAL OF HEAVY METALS AND METHOD FOR MANUFACTURING THE SAME

(71) Applicant: ALTWELLTECH INC., Daejeon (KR)

(72) Inventors: Hyuk-Won KWON, Daejeon (KR); Min-Jung PARK, Daejeon (KR); Sang-Soon PARK, Chungcheongnam-do (KR); Jeong-Hwan SEO, Incheon (KR)

(21) Appl. No.: 14/446,689

(22) Filed: Jul. 30, 2014

(30) Foreign Application Priority Data
Aug. 8, 2013 (KR) 10-2013-0094004

(51) Int. Cl. C02F 1/28

(52) U.S. Cl. CPC C02F 1/283; C02F 2101/203
USPC 210/502.1; 252/181

(57) ABSTRACT

A carbon block filter for removal of heavy metals and a method for manufacturing the same are disclosed. The carbon block filter includes 50 wt % to 60 wt % of activated carbon and 30 wt % to 40 wt % of an ultra-high molecular weight polyethylene binder. The filter further includes a heavy metal-removing agent to mold the carbon block filter. The heavy metal-removing agent is a sorted heavy metal-removing agent obtained by pulverizing Bayoxide E33G having a particle diameter of 0.5 mm to 2 mm or 1.0 μm to 1.4 μm and made in Germany and sorting only Bayoxide E33G having a particle size of 10 μm to 50 μm.

### BACKGROUND OF THE INVENTION

1. Field of the Invention

The invention relates to a carbon block filter for removal of heavy metals that includes a heavy metal-removing material verified through experimentation by which heavy metals that may be introduced into tap water and are conventionally removed only using a reverse osmosis (RO) membrane water purifier may be effectively removed even in a hollow fiber membrane-type water purifier. The invention also related to a method for manufacturing the carbon block filter.

2. Description of the Related Art

South Korea is one of the global leaders in the field of water purifiers. As interest of consumers conventionally interested only in design and mechanical performance is expanded to water purification performance, demand for water purifiers tends to continuously increase. Reverse osmosis (RO)-type water purifiers, which remove contaminants and even ionic minerals present in tap water, account for 60% or more of the domestic water purifier market due to marketing strategies of some big enterprises. However, such RO-type water purification is used for seawater as a tap water source or in places in which water quality of tap water sources is excessively poor including areas into which seawater is introduced and the like and is known to be unsuitable for use in drinking water purifiers, which are applied to the field that needs pure water, such as laboratories, pharmaceutical firms, and the like because such RO-type water purifiers filter even filter out most minerals that are helpful to human health.

As described above, commercially available water purifiers can be broadly divided into RO type and hollow fiber membrane type, in terms of water purification methods. Hollow fiber membranes are membranes developed for hemodialysis and have a pore size of 0.01 μm to 0.1 μm.

Such hollow fiber membrane-type water purifiers have physical performance such as filtering of particles having a size of 0.01 μm to 0.1 μm and filtering of pathogenic bacteria such as general bacteria and coliform bacteria, while being unable to remove minerals or heavy metal materials dissolved in water. Thus, such hollow fiber membrane-type water purifiers are referred to as mineral water purifiers and utilized in marketing. However, when tap water contains excess of heavy metal components, hollow fiber membrane-type water purifiers are unable to effectively purify water.

In water purifier systems, activated carbon filters and membrane filters are known to be core materials of water purifiers. An activated carbon filter absorbs and removes harmful materials remaining in water, such as chlorine, volatile organic compounds, and the like, and a membrane filter removes particulates in water by physical filtration. Thus, water purifiers maintain water purification performance by using the two filters in combination.

The technology of the present invention is to prepare a carbon block filter for removal of heavy metal components currently classified as specific items through studies using a carbon block filter developed and mass-produced by the company that filed the present invention and a functional additive.

Carbon blocks developed for removal of harmful materials significantly enhance performance of hollow fiber membrane-based water purification systems and thus are determined to be used in developing high-performance water purifiers that enables supply of mineral-containing water.

Conventional compressed carbon blocks have only a function of removing disinfection components in water, such as chlorine, chloroform, and the like, and volatile organic compounds (VOCs) and thus require technical know-how to complement performance. As a functional material used in the present invention, Bayoxide E33G manufactured by LANXESS, Germany, which is a material for removal of heavy metals, is used. Bayoxide E33G is molded in the form of granules (see FIG. 1) and applied to drinking water systems in villages in South Korea by filling a tank as a material for removal of heavy metals and arsenic. Some U.S. firms are selling expensive products manufactured by filling a housing of a filter for water purifiers with 200 g to 300 g of granules. The carbon block filter for removal of heavy metals of the present invention may be used as an economical next-generation hybrid filter due to superior performance and use in a smaller amount than a filter manufactured by filling Bayoxide E33G granules.

### SUMMARY OF THE INVENTION

To achieve the object of the present invention, the most important factor is to select particle sizes of a functional material, a binder, and powder-type activated carbon and to design a composition ratio thereof. A carbon block for removal of heavy metals requires physical properties such as minimization of water permeation resistance, i.e., non-fine pores of the carbon block and it is also necessary to develop an optimum composition ratio of the carbon block so as to effectively remove heavy metal components. For this, an optimum particle size and composition ratio were obtained through several tens of experiments and heavy metal removal performance according to amount of the functional material was evaluated by evaluating heavy metal removal ability of the carbon block filter.

As confirmed by the experiments, average particle diameters of activated carbon and the binder are 90 μm to 150 μm and 110 μm to 140 μm, respectively. The heavy metal removal performance is enhanced in proportion to an absolute amount of Bayoxide E33G sorted to have a certain particle size regardless of the size of the carbon block filter and the amount of carbon.

The carbon block filter may be designed as follows (composition 1). When a carbon block has a diameter of 31 mm to 50 mm and a height of 150 mm to 250 mm, a weight of Bayoxide E33G added, which is a heavy metal-removing agent, is 20 g to 35 g and a weight ratio of powder-type activated carbon to binder is 5-6: 3-4. When the weight of the heavy metal-removing agent is less than 20 g, heavy metal removal efficiency is deteriorated. On the other hand, when the weight of the heavy metal-removing agent exceeds 35 g, there is no difference in heavy metal removal efficiency and thus it is not economical.

In another embodiment, the carbon block filter may be designed as follows (composition 2). When a carbon block has a diameter of 51 mm to 63 mm and a height of 150 mm to 250 mm, a weight of Bayoxide E33G added, which is a heavy metal-removing agent, is 35 g to 120 g and a weight ratio of powder-type activated carbon to binder is 5-6: 3-4. When the weight of the heavy metal-removing agent is less than 35 g, heavy metal removal efficiency is deteriorated. On the other hand, when the weight of the heavy metal-removing agent exceeds 120 g, there is no difference in heavy metal removal efficiency and thus it is not economical.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an image of a heavy metal-removing agent manufactured in Germany; and

FIG. 2 is an image of the heavy metal-removing agent of FIG. 1 sorted to have a certain particle size.

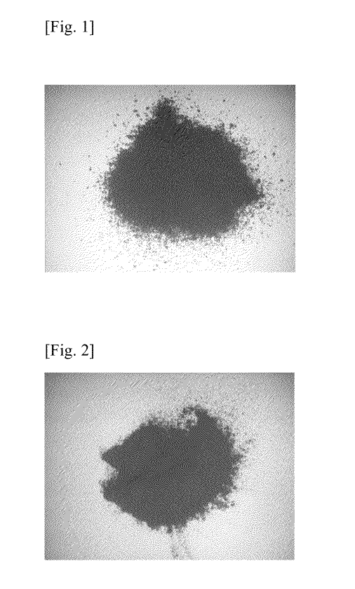

### DETAILED DESCRIPTION OF THE INVENTION

Hereinafter, the present invention will be described with reference to the accompanying drawings.

The present invention has been made to address the above-described problems of the related art. An ultra-high molecular weight polyethylene (UHMWPE) binder made in Korea is used and has physical properties such as a melting point of 130.1° C., a bulk density of 0.45 to 0.55 g/cm³, a molecular weight of 4,500,000 to 5,000,000 g/mol, and an average particle diameter of about 110 μm to about 140 μm. Binders developed and produced by a company with an initial of D in Korea have physical properties of general UHMWPE and are products that may be mainly applied to engineering plastics, high-functional fibers, a variety of sporting goods, and the like and, currently, only products with limited particle diameter, i.e., an average particle diameter of 110 μm to 140 μm, are produced. The patent filed by the company prior to the present application (Korean Patent Publication No. 10-2013-0045641) discloses a method of controlling pores of a block filter by adjusting particle sizes of activated carbon and a binder.

A functional material is in the form of granules having certain sizes of particles and thus cannot be used in block molding without adjustment of particle size. This is because size and weight of functional particles are different and thus particles of activated carbon and particles of the binder cannot be uniformly mixed. Bayoxide

E33G, used as a main raw material of heavy metal filters, has two types in terms of particle diameter: 10 to 35 mesh (0.5 to 2 mm) and 14 to 18 mesh (1.0 to 1.4 mm). The applicant of the present invention discovered an optimum particle size of Bayoxide E33G by molding a block filter through adjustment of particle size and evaluation of physical characteristics and performance of the block filter. An optimum average particle diameter obtained by pulverization and sorting using a particle size adjustment technology of the present applicant is 10 μm to 50 μm (see FIG. 2). In summary, from experimental results, it can be confirmed that, when the average particle diameter of the block filter is less than or equal to 10 μm, the particle size thereof is too small and thus a carbon block has narrowed pores and, accordingly, water permeation resistance significantly increases, which makes fabrication of efficient filters difficult and, on the other hand, when the average particle diameter of the block filter greater than or equal to 50 μm, mixing uniformity is deteriorated and thus uniform mixing is not performed in the carbon block and contact time with heavy metals is short due to large specific surface area, which results in reduced heavy metal removal ability. As a result of studies, average particle diameters of activated carbon and the binder so as to have the most efficient water permeation amount are 90 μm to 150 μm and 110 μm to 140 μm, respectively. This is a particle size enabling molding of a block with pores having a size of about 5 μm. When comparing a carbon block filter manufactured by adjusting a particle size of a carbon block for removal of heavy metals, developed through the above-described process, with a filter using granule-type Bayoxide E33G, the carbon block filter exhibits a greater heavy metal removal ability, i.e., approximately 8.3 times that of the filter and thus has enhanced performance and economic efficiency.

Composition and Manufacture of Carbon Block for Removal of Heavy Metals, having External Diameter of 31 mm to 50 mm

### EXAMPLE 1

Activated carbon having an average particle diameter of 110 μm and a binder having an average particle diameter of 120 μm were prepared to have a weight ratio of 6:4. Subsequently, 30 g of Bayoxide E33G, a particle size of which was sorted into 40 μm, was mixed with the activated carbon and the binder and the resulting mixture was molded. Experimental results of heavy metal removal performance are shown in Tables 1 and 2 below.

TABLE 1

| Item | | Pb | Cr⁶⁺ | As | Se | Fe | Al | Cu | Hg |
|---|---|---|---|---|---|---|---|---|---|
| Removal rate | | 90 | 90 | 90 | 90 | 80 | 80 | 70 | 90 |
| according to water | | | | | | | | | |
| mark standard (%) | | | | | | | | | |
| Comparative | 0 g of | 92.8 | 51.9 | 63.6 | 42.5 | 91.8 | 89.7 | 68.5 | 42.3 |
| Example 1 | additive | | | | | | | | |
| Example 1 | 30 g of | 99.8 | 97 | 95.4 | 100 | 100 | 100 | 98.9 | 100 |
| (external | additive | | | | | | | | |
| diameter of | | | | | | | | | |
| 31 mm) | | | | | | | | | |
| Example 2 | 30 g of | 99.4 | 97.5 | 98.9 | 100 | 100 | 100 | 99.3 | 100 |
| (external | additive | | | | | | | | |
| diameter of | | | | | | | | | |
| 40 mm) | | | | | | | | | |
| Example 3 | 30 g of | 99.9 | 98 | 97.5 | 100 | 100 | 100 | 99.2 | 100 |
| (external | additive | | | | | | | | |
| diameter of | | | | | | | | | |
| 50 mm) | | | | | | | | | |

Removal performance of eight heavy metals (Water mark standard: satisfaction of removal rate reference value after permeation of 100 L of water)

TABLE 2

| Permeation | Concentration | Outflow | | Water |
|---|---|---|---|---|
| amount of | of raw water | concentration | Removal | permeation |
| water (L) | (ppb) | (ppb) | rate (%) | rate (L/min) |
| 0 | 60.5 | 0.0 | 100 | 2 |
| 200 | 51.2 | 0.0 | 100 | 2 |
| 400 | 52.3 | 0.0 | 100 | 2 |
| 600 | 49.5 | 0.0 | 100 | 2 |
| 800 | 50.1 | 0.0 | 100 | 2 |
| 1000 | 52.1 | 0.0 | 100 | 2 |
| 1200 | 53.4 | 0.0 | 100 | 2 |
| 1400 | 49.8 | 1.1 | 98 | 2 |
| 1600 | 54.2 | 2.4 | 95.4 | 2 |
| 1800 | 52.6 | 9.5 | 82 | 2 |

Removal performance of arsenic (Removal rate according to U.S. NSF standard: outflow concentration of 10 ppb or less)

In this regard, arsenic removal performance of a filter manufactured by adding 30 g of Bayoxide, which is a heavy metal-removing agent, as an additive was evaluated.

### EXAMPLE 2

A carbon block was manufactured in the same manner as in Example 1, except that a filter for removal heavy metals was molded to have an external diameter of 40 mm. Results are shown in Tables 1 and 2 above.

### EXAMPLE 3

A carbon block was manufactured in the same manner as in Example 1, except that a filter for removal heavy metals was molded to have an external diameter of 50 mm. Results are shown in Tables 1 and 2 above.

Composition and Manufacture of Carbon Block for Removal of Heavy Metals, having External Diameter of 51 mm to 63 mm

### EXAMPLE 4

Activated carbon having an average particle diameter of 90 μm and a binder having an average particle diameter of 110 μm were prepared to have a weight ratio of 6:4. Subsequently, 90 g of Bayoxide E33G, a particle size of which was sorted into 40 μm, was mixed with the activated carbon and the binder and the resulting mixture was molded. Experimental results of heavy metal removal performance are shown in Tables 3 to 5 below.

TABLE 3

| Item | | Pb | Cr⁶⁺ | As | Se | Fe | Al | Cu | Hg |
|---|---|---|---|---|---|---|---|---|---|
| Removal rate | | 90 | 90 | 90 | 90 | 80 | 80 | 70 | 90 |
| according to water | | | | | | | | | |
| mark standard (%) | | | | | | | | | |
| Comparative | 0 g of | 94.1 | 54.2 | 65.1 | 44.5 | 93.2 | 90.5 | 68.9 | 44.7 |
| Example 2 | additive | | | | | | | | |
| (external | | | | | | | | | |
| diameter of | | | | | | | | | |
| 60 mm) | | | | | | | | | |
| Example 4 | 90 g of | 100 | 100 | 100 | 100 | 100 | 100 | 100 | 100 |
| (external | additive/ | | | | | | | | |
| diameter of | 100 L | | | | | | | | |
| 60 mm) | | | | | | | | | |
| Example 5 | 90 g of | 100 | 100 | 100 | 100 | 100 | 100 | 100 | 100 |
| (external | additive/ | | | | | | | | |
| diameter of | 100 L | | | | | | | | |
| 63 mm) | | | | | | | | | |
| Example 6 | 90 g of | 100 | 100 | 100 | 90 | 100 | 100 | 100 | 100 |
| (external | additive/ | | | | | | | | |
| diameter of | 100 L | | | | | | | | |
| 51 mm) | | | | | | | | | |

Removal performance of eight heavy metals (Removal performance and capacity were evaluated after preparing raw water with a concentration according to water mark standard)

In this regard, heavy metal removal performance of a filter manufactured by adding 90 g of the heavy metal-removing agent was evaluated.

TABLE 4

| Permeation | Concentration | Outflow | | Water |
|---|---|---|---|---|
| amount of | of raw water | concentration | Removal | permeation |
| water (L) | (ppb) | (ppb) | rate (%) | rate (L/min) |
| 0 | 61.9 | 0.0 | 100 | 2 |
| 200 | 61.9 | 0.0 | 100 | 2 |
| 400 | 57.8 | 0.0 | 100 | 2 |
| 600 | 57.8 | 0.0 | 100 | 2 |
| 800 | 57.8 | 0.0 | 100 | 2 |
| 1000 | 56.1 | 0.0 | 100 | 2 |
| 1200 | 56.1 | 0.0 | 100 | 2 |
| 1400 | 56.1 | 0.0 | 100 | 2 |
| 1600 | 51.6 | 0.0 | 100 | 2 |
| 1800 | 51.6 | 0.0 | 100 | 2 |
| 2000 | 45.1 | 0.0 | 100 | 2 |
| 2200 | 45.1 | 0.0 | 100 | 2 |
| 2400 | 45.1 | 0.0 | 100 | 2 |
| 2600 | 48.4 | 0.0 | 100 | 2 |
| 2800 | 48.4 | 0.0 | 100 | 2 |
| 3000 | 47.4 | 0.0 | 100 | 2 |
| 3200 | 47.4 | 0.0 | 100 | 2 |
| 3400 | 47.3 | 0.0 | 100 | 2 |
| 3600 | 47.5 | 0.0 | 100 | 2 |
| 3800 | 47.3 | 0.0 | 100 | 2 |
| 4000 | 47.3 | 3.5 | 92.6 | 2 |
| 4200 | 61.4 | 0.0 | 100 | 2 |
| 4400 | 47.5 | 2.7 | 94.3 | 2 |
| 4600 | 56.4 | 0.0 | 100 | 2 |
| 4800 | 56.4 | 9.6 | 83.0 | 2 |
| 5000 | 61.4 | 10.5 | 82.9 | 2 |
| 5200 | 61.4 | 15.6 | 74.6 | 2 |
| 5400 | 61.4 | 23.3 | 62.1 | 2 |

Arsenic removal performance (Removal rate according to U.S. NSF standard: outflow concentration of 10 ppb or less)

In this regard, the arsenic removal performance of a filter manufactured by adding 90 g of the heavy metal-removing agent was evaluated.

TABLE 5

| Permeation | Concentration | Outflow | | Water |
|---|---|---|---|---|
| amount of | of raw water | concentration | Removal | permeation |
| water (L) | (ppb) | (ppb) | rate (%) | rate (L/min) |
| 0 | 60 | 0.0 | 100 | 2.0 |
| 200 | 58.6 | 0.0 | 100 | 2.0 |
| 400 | 58.6 | 10.0 | 100 | 2.0 |
| 600 | 52.8 | 9.3 | 82.4 | 2.0 |

Confirmation of arsenic removal performance of a filter manufactured through filling of 90 g of Bayoxide E33G prior to particle sorting

(Comparison in Performance with a Carbon Block for Removal of Heavy Metals)

Quantitative comparison in removal performance between a filter filled with 90 g of Bayoxide E33G prior to particle sorting and a carbon block filter for removal of heavy metals, manufactured using 90 g of Bayoxide E33G after particle sorting, in which the same weight of Bayoxide E33G was used, was performed. As a result of comparison, the carbon block filter exhibited a greater removal performance, i.e., 8.3 times that of the filter filled with the heavy metal-removing agent. Thus, raw material cost of Bayoxide E33G, which is expensive, may be reduced by 8 times or more and, accordingly, a technology of manufacturing a high-performance filter for removal of heavy metals, which reduces import costs and is economical, is achieved.

### EXAMPLE 5

A carbon block was manufactured in the same manner as in Example 4, except that a filter for removal heavy metals was molded to have an external diameter of 63 mm. Results are shown in Table 3 above.

### EXAMPLE 6

A carbon block was manufactured in the same manner as in Example 4, except that a filter for removal heavy metals was molded to have an external diameter of 51 mm. Results are shown in Table 3 above.

As described above, the present invention aims to develop an optimum composition that enables removal of heavy metals through an optimum design composition ratio for preparation of a hybrid composite functional carbon block having both functions of a carbon block and a functional material by discovering optimum particle size and amount that enables excellent functionality through adjustment of particle size of the functional material in development of a functional carbon block.

In general, it is difficult to remove ionic materials in hollow fiber membrane type water purifiers excluding reverse osmosis type water purifiers. According to the present invention, a functional filter that has superior heavy metal removal performance to a hollow fiber membrane type water purifier and thus enables filtered water to maintain properties of tap water with abundant minerals and is able to remove heavy metals present in tap water in emergency situations is manufactured and thus may enhance water purifier performance and is anticipated to be widely used as a marketing strategy of water purifier firms.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing a carbon block filter for removal of heavy metals, the method comprising:
pulverizing Bayoxide E33G having a particle diameter of 0.5 mm to 2 mm or 1.0 μm to 1.4 μm and sorting only Bayoxide E33G having a particle size of 10 μm to 50 μm, the Bayoxide E33G being made in Germany and a heavy metal-removing agent;
mixing powder-type activated carbon and an ultra-high molecular weight polyethylene binder having an average particle diameter of 110 μm to 140 μm, in a weight ratio of 5-6:3-4, with the sorted heavy metal-removing agent; and
molding a carbon block filter.

2. The method according to claim 1, wherein the carbon block filter has a diameter of 31 mm to 50 mm and a height of 150 mm to 250 mm, and the heavy metal-removing agent is added in an amount of 20 g to 35 g.

3. The method according to claim 1, wherein the carbon block filter has a diameter of 51 mm to 63 mm and a height of 150 mm to 250 mm, and the heavy metal-removing agent is added in an amount of 20 g to 35 g.

4. A carbon block filter for removal of heavy metals, comprising:
50 wt % to 60 wt % of activated carbon; and
30 wt % to 40 wt % of an ultra-high molecular weight polyethylene binder, and further comprising a heavy metal-removing agent to mold the carbon block filter,
wherein the heavy metal-removing agent is a sorted heavy metal-removing agent obtained by pulverizing Bayoxide E33G having a particle diameter of 0.5 mm to 2 mm or 1.0 μm to 1.4 μm and made in Germany and sorting only Bayoxide E33G having a particle size of 10 μm to 50 μm.

5. The carbon block filter according to claim 3, wherein the carbon block filter has a diameter of 31 mm to 50 mm and a height of 150 mm to 250 mm, and the heavy metal-removing agent is added in an amount of 20 g to 35 g.

6. The carbon block filter according to claim 3, wherein the carbon block filter has a diameter of 51 mm to 63 mm and a height of 150 mm to 250 mm, and the heavy metal-removing agent is added in an amount of 35 g to 120 g.
